(19) United States
(12) Patent Application Publication
(10) Pub. No.: US 2004/0088334 A1
(43) Pub. Date: May 6, 2004

(54) System and method for generating reports for a versioned database

(76) Inventor: Ralph Wilhelm Klein, Sherwood Park (CA)

Correspondence Address: FISH & NEAVE, 1251 AVENUE OF THE AMERICAS, 50TH FLOOR, NEW YORK, NY, 10020-1105, US

(21) Appl. No.: 10/287,555

(22) Filed: Nov. 1, 2002

(51) Int. Cl. G06F 12/00

(52) U.S. Cl. 707/203

(57) ABSTRACT

A system and method for efficiently storing multiple versions of a data object in a database and generating a report to display a single version of a data object corresponding to any given time are provided. The data object is represented by a versioned data structure that includes a belief time field for storing a belief time corresponding to a version of the data object. A single version of the data object is retrieved by generating SQL code including a select clause for specifying the fields that are required for retrieving the data object and a where clause for specifying the version of the data object to be retrieved. A single foreign key is used to access multiple versions of the same data object.

### BACKGROUND OF THE INVENTION

This invention relates generally to the management of versioned data in a database. More specifically, the present invention relates to a system and method for storing multiple versions of a data object in a database and generating a report to display a single version of a data object corresponding to any given time.

The advent of the Internet and Information Technology (“IT”) has revolutionized the way business is conducted around the world. Business organizations have adopted these technologies to organize their structure, work flow and business relationships and to make their business processes increasingly more efficient. In particular, these technologies have become instrumental in enabling business organizations to manage the large amounts of data transacted by them on a daily basis.

The data generated by a given business organization is typically stored in various databases across the business organization's information systems. A database is a collection of data that is organized so that its contents may be easily accessed, managed, and updated. The data stored in a database and the algorithms used to manipulate the data are represented in computer memory by a data structure, such as a queue, linked list, stack, heap, tree, or hash table, among others.

The most prevalent type of database is the relational database, organized as a set of formally-described tables from which data may be accessed or reassembled in many different ways without having to reorganize the tables. Each table, also referred to as a relation, contains one or more data categories in columns. Each row in the table contains a unique data record or instance of data for a data object represented by the categories defined by the columns. Each row in the table is uniquely identified by a primary key, which may be any column or columns in the table that uniquely identifies a row. Typically, a table will contain a column to hold unique integer values to act as a default primary key. The integer values may be automatically assigned by the database, usually generated incrementally. A primary key consisting of more than one column is commonly referred to as a composite primary key.

For example, an electronic commerce web site such as Amazon.com, of Seattle, Calif., may have a relational database to describe customers' orders. The relational database may include a table to store customers' personal information with columns for the customers' name, address, and credit card, and another table to describe the order itself, with columns for the product bought, its price and quantity. The customer and the customer's order are data objects and each row in the table would contain a data record or instance of data for a given object. The tables may include an ID column to uniquely identify each data record with an integer value and to serve as the tables' primary keys. Alternatively, the first name and the last name of a given customer may be used as a composite primary key in the customer's personal information table.

Data may be queried from a database using a standard application program interface called Structured Query Language (“SQL”). SQL enables a user to select, insert, delete, update, and find out the location of data, among other data operations. The user may specify SQL statements to manipulate data in a database as part of a relational database management system (“RDBMS”), which is a program for creating, updating, and administering a relational database. Examples of commercially available RDBMSs include DB2, sold by IBM Corporation, of White Plains, N.Y., Oracle 9i Database, sold by Oracle Corporation, of Redwood Shores, Calif., and OpenIngres, sold by Computer Associates International, Inc., of Islandia, N.Y. Alternatively, business organizations may use spreadsheet software applications such as Excel, sold by Microsoft Corporation, of Redmond, Wash., to emulate a RDBMS.

Business organizations often use commercially available RDBMSs to manage databases storing their customer, supplier, and internal data such as accounting and financial information, employees' records, inventory, and legal records, among others.

Additionally, business organizations in industries such as construction and manufacturing may require more specialized RDBMSs to manage activity-based costing data involving various business activities and the determination of costs and cost drivers for each activity. An example of activity-based costing data includes the material and labor costs of a construction unit or the costs generated by a given purchase order or machine use. Commercially-available activity-based costing RDBMSs include Prolog Manager and Prolog Scheduler, sold by Meridian Project Systems, Inc., of Folsom, Calif., and the OneWorld software package, sold by J.D. Edwards & Company, of Denver, Colo.

A primary function of these activity-based costing systems is to highlight variances between actual costs and budgeted costs on an ongoing basis. To ensure accurate and consistent calculation of actual costs, these systems implement database queries that require the consideration of a large number of variables. These variables can include resource identification and classification, project, phase and task references, cost code references, and date and time, among others. Transactions that drive the calculation of actual costs in these systems must accurately record each of these variables in order to generate the correct results.

This requires the RDBMSs to keep a historical record of all data records and transactions generated by the business organization. A common strategy for maintaining history in a database is to track the effective date of a data object by making all updates to the data object a new version for that object in the database. Each version corresponds to a single data record or row in the database and includes one or more date fields to indicate at what point in time a particular representation of a data object applies. SQL queries can then be used to return the set of rows or versions that apply to any point in time by using date ranges against the date fields in the database.

For example, a business organization may have a labor database to store information about their employees, with a personal information table to store the employees' personal information with columns for the employees' name and address and another work table to describe employees' roles in the business organization, with columns for their business title, skills, hours worked on a given day, and the business unit they belong to. To keep track of an employee's progress, the business organization may be required to store a history of the employee's work with the business organization. Each version or row in the work table for a given data object or employee may contain a “start date” and an “end date” field to indicate the period of time during which the employee was working for a particular business unit. Alternatively, each version may be represented with a single date field to indicate that the version is valid from the date indicated in the date field. In either case, keeping a historical record of the employee's work life in the business organization is a matter of adding new versions or rows to the work table whenever the employee's role within the business organization changes. A SQL query may then be used to find out in which business unit the employee was working during a given time period.

In a more complex scenario, the business organization may have to include for each data object one or more foreign keys to refer to other data objects stored within the same table or at a different table. A foreign key is a set of one or more columns in any table which may hold the value(s) found in the primary key column(s) of some other table. In the example above, the work table may include an ID column with integer values to serve as the table's primary key and a name column to serve as foreign keys to the personal information table.

However, when multiple versions of a data object are stored in a table, it may be difficult to refer to other objects using a single foreign key since the foreign key may resolve to one or more versions of the same data object. For example, the name column may refer to multiple versions of a given employee in the personal information table, with each version corresponding to different addresses kept by the employee while working for the business organization.

At present, there are no RDBMSs capable of using a single foreign key to resolve to a single version of a versioned data object. To extract a single version of a versioned data object using the current RDBMSs would require the use of a composite foreign key including a date field to refer to the version desired, or the use of non-traditional foreign keys customized to a particular database design. In the example above, finding out an employee's address at a given point in time would require the use of a composite foreign key including the name of the employee as well as a date foreign key to correspond to the time desired. The use of composite foreign keys to access versioned data objects, however, is cumbersome and difficult to maintain. Frequent changes to data records may require frequent changes to the foreign keys themselves.

Furthermore, currently available database reporting tools such as Crystal Reports, provided by Crystal Decisions, Inc., of Palo Alto, Calif., Oracle Reports, provided by Oracle Corporation of Redwood Shores, Calif., and Cognos, provided by Cognos, Inc., of Ottawa, Canada, are not able to generate database reports for versioned data objects requiring non-traditional foreign keys for extracting a single version of a given data object. Database reporting tools are often used to produce textual, graphical, or multimedia reports or displays of data objects in a database. While these reporting tools enable business organizations to view their data objects seamlessly, they are not able to produce queries of versioned data objects at any given time when the data objects are stored in non-traditional ways and refer to other data objects using a single foreign key.

In view of the foregoing, it is an object of the present invention to provide systems and methods for efficiently storing multiple versions of a data object in a database.

It is a further object of the present invention to provide systems and methods for using a single foreign key to resolve to a single version of a versioned data object.

It is also an object of the present invention to provide systems and methods for generating a database report to display a single version of a data object corresponding to any given time.

### SUMMARY OF THE INVENTION

These and other objects of the invention are accomplished in accordance with the principles of the present invention by providing systems and methods for efficiently storing multiple versions of a data object in a database and retrieving a single version of the data object for generating a database report for any given point in time. A data object represents an entity to be stored in a table and is associated with different fields or categories. For example, a data object may represent an employee associated with a name field and an employee number field.

Each version of a data object corresponds to a single data record or row in a table and includes a belief time field to indicate the date and time the data record was entered in the table, that is, the date and time from which the data record is believed to be valid. Each version may also include a foreign key to refer to other data objects. The foreign key may resolve to multiple versions of a given data object. A single version of a given data object may be queried by associating foreign key resolution to the belief time.

In a preferred embodiment, the system of the present invention may involve four main software components: (1) a versioned data structure for storing versioned data objects in a table with a single foreign key; (2) a customized data dictionary for describing the versioned data objects; (3) a custom trigger for enforcing a single foreign key against a versioned data object; and (4) a query generator for retrieving a version of a data object from a table.

The versioned data structure represents a versioned data object with a primary key field to uniquely identify the data object, fields descriptive of the data object, a belief time field to indicate the date and time from which the data record is believed to be valid, a foreign key field to refer to another data object in the table using the primary key, and a version number field to indicate each version of the data object in the table.

The fields are specified in a customized data dictionary, which contains all the information pertaining to the data objects, such as the values the data objects may have, and textual descriptions of the data objects, among other information that may be used to fully describe a data object.

Data object integrity is enforced by a custom trigger that verifies that the values assigned to the foreign key field are supported in the table. The custom trigger is invoked whenever a new version for a given data object is inserted in the table.

A version for a given data object is retrieved from the table by using the query generator. The query generator is implemented as a function with two input parameters, namely the fields desired in retrieving the version and a filter to limit the versions that are returned by a query. The query generator parses the parameters and generates SQL code to extract versions for a given data object in the table. A belief time is then set for each query generator request in order to execute the SQL code to return a single version for a given data object. A formatted database report may be produced to display the desired version by using a commercially available report presentation tool.

Advantageously, the system and method of the present invention enable business organizations to efficiently store multiple versions of data objects and retrieve a single version of the data object for generating a database report for any given point in time.

### BRIEF DESCRIPTION OF THE DRAWINGS

The foregoing and other objects of the present invention will be apparent upon consideration of the following detailed description, taken in conjunction with the accompanying drawings, in which like reference characters refer to like parts throughout, and in which:

FIG. 1 is a schematic diagram of the software components used in accordance with the principles of the present invention;

FIG. 2 is a schematic diagram of the versioned data structure;

FIG. 3 is an illustrative diagram of a table for representing employee information using the versioned data structure;

FIG. 4 is a flow chart for retrieving a single version of a data object from a table using the query generator; and

FIG. 5 is an illustrative diagram of query generator parameters, associated SQL code generated by the query generator from the parameters, and results produced by the query generator for a set of belief times.

### DETAILED DESCRIPTION OF THE DRAWINGS

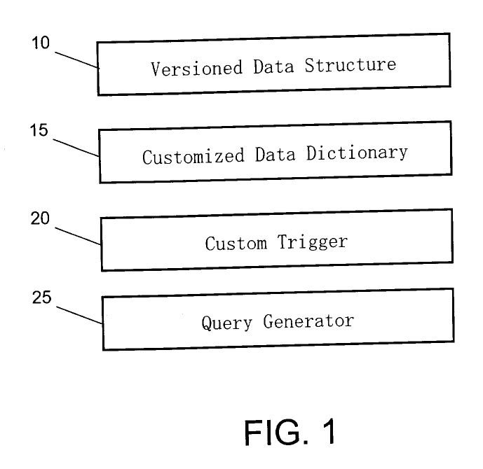

Referring to FIG. 1, a schematic diagram of the software components used in accordance with the principles of the present invention is described. Versioned data structure 10 represents a versioned data object with several fields, including: (1) a primary key field to uniquely identify a data object; (2) descriptive fields specifying features particular to the data object; (3) a belief time field to indicate the date and time from which the data record is believed to be valid; (4) a foreign key field to refer to another data object in the table using the primary key; and (5) a version number field to indicate each version of the data object in the table.

The fields are specified in customized data dictionary 15, which contains all the information pertaining to the data objects stored in a table, such as the values the data objects may have and textual descriptions of the data objects, among other information that may be used to fully describe a data object.

Data object integrity is enforced by custom trigger 20 that verifies that the values assigned to the foreign key field are supported in the table. Custom trigger 20 is invoked whenever a new version for a given data object is inserted in the table.

Query generator 25 is a function for retrieving from the table one or more versions of a given data object. Query generator 25 takes two input parameters, namely the fields desired in retrieving the versions and a filter to limit the versions that are returned by a query. Query generator 25 parses the parameters and generates SQL code to extract versions for a given data object in the table. A belief time is then set for each request to query generator 25 in order to execute the SQL code to return a single version for a given data object. A formatted database report may then be produced to display the desired version by using a commercially available report presentation tool.

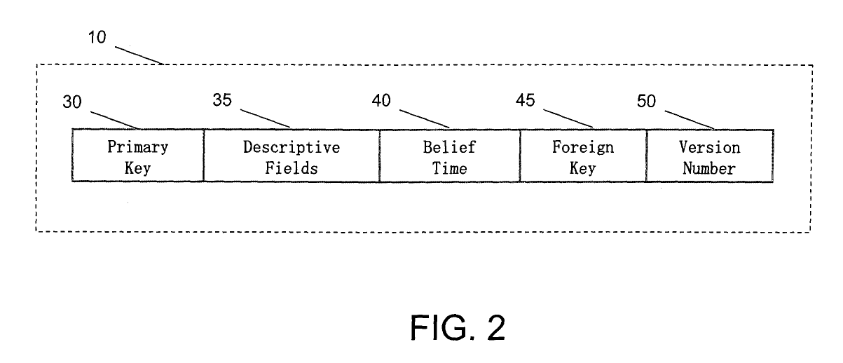

Referring now to FIG. 2, a schematic diagram of the versioned data structure is described. Versioned data structure 10 represents a versioned data object with several fields, including: (1) primary key field 30; (2) descriptive fields 35; (3) belief time field 40; (4) foreign key field 45; and (5) version number field 50.

Primary key field 30 is used to uniquely identify a data object with an integer value, text, ascii code, or other representation that may be used to uniquely identify a row in a database table.

Descriptive fields 35 include one or more fields that may be used to describe features of a given object. For example, an employee data object may have a first name field, a last name field, and an address field to describe it.

Belief time field 40 is used to indicate the date and time a given version of a data object is inserted into a table. Belief time 40 also indicates the date and time from which the version is believed to be valid. Storing multiple versions of data objects using belief time field 40 enables users to extract any time representation of a data object, such as the current version of the data object. Belief time field 40 also enables users to perform a complete audit of a database during any given time period by querying the database for all the versions that have values for belief time field 40 corresponding to the time period in question.

Version number field 50 is a unique ID to uniquely identify each version of a given data object stored in the database table. Lastly, foreign key field 45 represents, for a given data object, a reference to another data object using primary key field 30.

It should be understood by one skilled in the art that additional fields may be used to represent versioned data in a database.

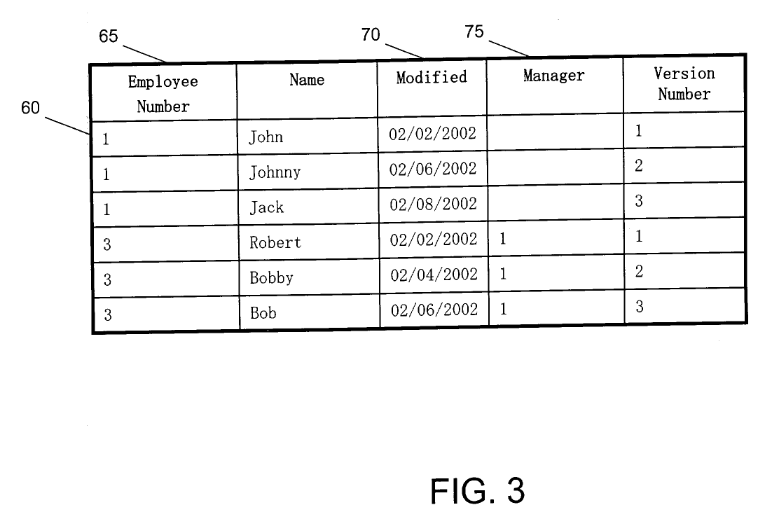

Referring now to FIG. 3, an illustrative diagram of a table for representing employee information using the versioned data structure is described. Table 60 represents versioned employee information for a business organization, that is, table 60 is used to store information pertaining to data objects consisting of employee records. Primary key field 30 is represented in table 60 with incremental integer values to designate employee numbers, with each value referring to a data object in table 60. Descriptive fields 35 are represented in table 60 by single employee name field 65 listing the names the employees' want to be called by their colleagues in the business organization. Belief time 40 is represented in table 60 by modified field 70, indicating the date in which a given version identified by primary key field 30 was entered in table 60, that is, the date in which a given employee's name was modified in table 60.

Finally, foreign key field 50 is represented by manager field 75, indicating the manager of each employee in table 60. Table 60 also has version number field 55 to uniquely identify each employee's version.

For example, employee 1 was referred to as John on Feb. 2, 2002, Johnny on Feb. 6, 2002, and Jack on Feb. 8, 2002. Similarly, employee 3 was referred to as Robert on Feb. 2, 2002, Bobby on Feb. 4, 2002, and Bob on Feb. 6, 2002. Employee 3 is managed by employee 1, as indicated by the values of manager field 75 of versions 1, 2, and 3 of employee 3. To determine the name of employee 3's manager, the value of manager field 75 must be looked up in table 60 with a corresponding belief time or value for modified field 70. If no belief time is associated with the value of manager field 75, the value of manager field 75 when used as a foreign key in table 60 resolves to three different versions of employee 1. The value of manager field 75 is enforced by custom trigger 20.

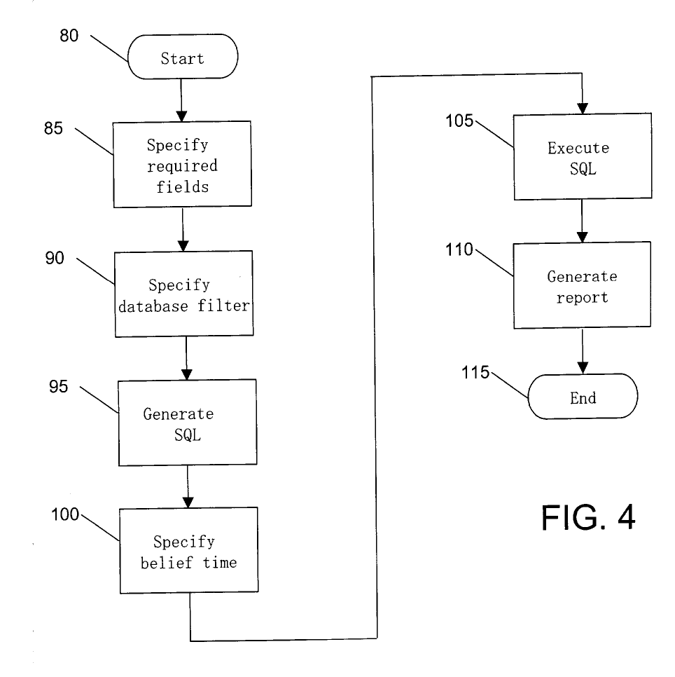

Referring now to FIG. 4, a flow chart for retrieving a single version of a data object from a table using the query generator is described. At step 85, the fields that are required to retrieve the version of the data object are specified. For example, a user may desire to view the current version of employee 3 stored in table 60 (FIG. 3) by displaying the employee's name and his manager.

At step 90, the filter used to limit the versions that are returned for a given query is specified. At step 95, the parameters are parsed and corresponding SQL code is generated. To return a single version of a data object in the table, the belief time is set at step 100. Finally, the SQL code is executed at step 105 and a report generated at step 110. The SQL query is generated by analyzing the required fields against customized data dictionary 15. In the example above, query generator 25 would find that the current manager of employee 3 is called “Jack.”

It should be understood by one skilled in the art that additional steps may be used to retrieve a single version of a data object from a versioned table in a database.

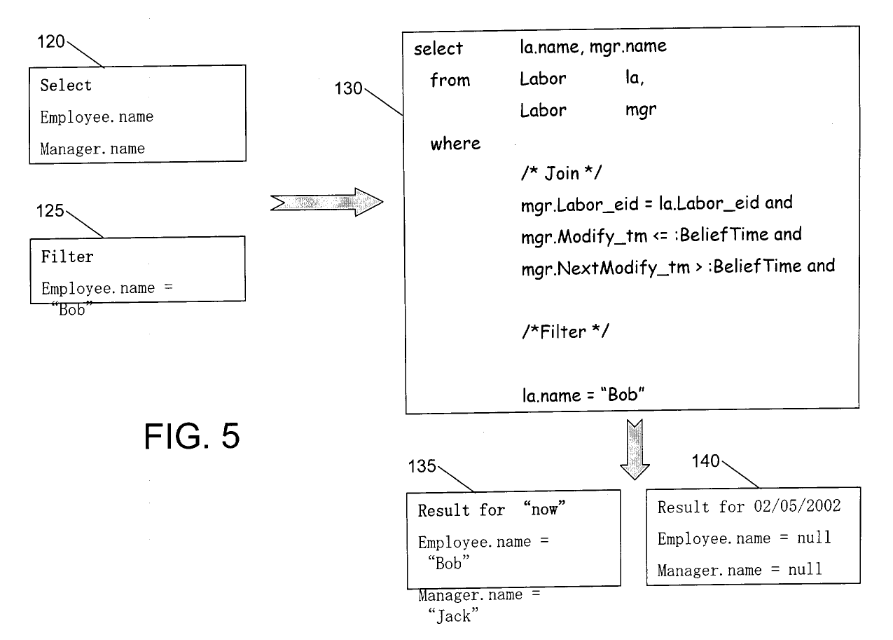

Referring now to FIG. 5, an illustrative diagram of query generator parameters, associated SQL code generated by the query generator from the parameters, and results produced by the query generator for a set of belief times are described. Query generator parameters 120 are specified for retrieving an employee data object from table 60 by listing the employee's name and his manager. Filter 125 is specified to return all employees called “Bob.” Running query generator 25 with parameters 120 and filter 125 results in SQL code 130. SQL code 130 has a “where” clause to retrieve from table 60 one version of an employee at a given belief time.

Executing SQL code 130 with a belief time of “now” returns the current version of all employees named “Bob”, which in table 60 resolves to version 135. Similarly, executing SQL code 130 with a belief time of “Feb. 5, 2002” returns version 140 having null values for the employee's-name and his manager's name, as no employee named “Bob” is listed in table 60 on that day.

Although particular embodiments of the present invention have been described above in detail, it will be understood that this description is merely for purposes of illustration. Specific features of the invention are shown in some drawings and not in others, for purposes of convenience only, and any feature may be combined with other features in accordance with the invention. Steps of the described processes may be reordered or combined, and other steps may be included. Further variations will be apparent to one skilled in the art in light of this disclosure and such variations are intended to fall within the scope of the appended claims.

What is claimed is:

1. A method for maintaining a history of a data object in a database and querying the database for a version of the data object, the method comprising:
providing a versioned data structure for representing the data object with multiple versions;
providing a single foreign key for referencing the data object;
generating a query routine for retrieving the version of the data object from the database; and
executing the query routine for a specified time to retrieve the version of the data object from the database corresponding to the specified time.

2. The method of claim 1, wherein providing a versioned data structure for representing the data object with multiple versions comprises providing a data structure comprising a plurality of fields comprising one or more of: a primary key field; a descriptive field; a belief time field; a foreign key field; and a version number field.

3. The method of claim 2, wherein providing a data structure comprising a descriptive field comprises providing a field for specifying a feature of a version of the data object.

4. The method of claim 2, wherein providing a data structure comprising a belief time field comprises providing a field for specifying the time the version of the data object was entered in the database.

5. The method of claim 2, wherein providing a data structure comprising a foreign key field comprises providing a field for referencing a data object in the database using the primary key field.

6. The method of claim 2, wherein providing a data structure comprising a version number field comprises providing a field for uniquely identifying the version of the data object.

7. The method of claim 1, wherein providing a single foreign key for referencing a data object comprises using the single foreign key to resolve to the multiple versions of the data object identified by the value of the single foreign key.

8. The method of claim 1, wherein generating a query routine for retrieving the version of the data object from the database comprises specifying one or more fields from the plurality of fields for retrieving the version of the data object.

9. The method of claim 1, wherein generating a query routine for retrieving the version of the data object from the database further comprises specifying a filter.

10. The method of claim 1, wherein executing the query routine comprises parsing one or more fields from the plurality of fields with the filter for generating a SQL routine.

11. The method of claim 1, wherein executing the query routine for a specified time to retrieve the version of the data object from the database corresponding to the specified time comprises executing the SQL routine with a specified belief time to generate the version of the data object valid for the specified belief time.

12. A system for maintaining a history of a data object in a database and querying the database for a version of the data object, the system comprising:
a versioned database for storing the data object with multiple versions;
a custom trigger routine for enforcing a single foreign key against the multiple versions; and
a query routine for retrieving a version of the data object at a specified time.

13. The system of claim 12, wherein the versioned database comprises a plurality of fields comprising one or more of: a primary key field; a descriptive field; a belief time field; a foreign key field; and a version number field.

14. The system of claim 13, wherein the descriptive field comprises a field for specifying a feature of a version of the data object.

15. The system of claim 13, wherein the belief time field comprises a field for specifying the time the version of the data object was entered in the database.

16. The system of claim 13, wherein the foreign key field comprises providing a field for referencing a data object in the database using the primary key field.

17. The system of claim 13, wherein the version number field comprises providing a field for uniquely identifying the version of the data object.

18. The system of claim 12, wherein the query routine comprises:
a select parameter for specifying a plurality of fields for retrieving the version of the data object;
a filter; and
a SQL routine comprising a belief time parameter.
